(19) United States
(12) Patent Application Publication
(10) Pub. No.: US 2025/0023375 A1
(43) Pub. Date: Jan. 16, 2025

(54) Vehicle Battery

(71) Applicant: Bayerische Motoren Werke Aktiengesellschaft, Muenchen (DE)

(72) Inventor: Markus WOERNER, Eichstaett (DE)

(21) Appl. No.: 18/712,158

(22) PCT Filed: Dec. 1, 2022
(86) PCT No.: PCT/EP2022/084018

§ 371 Date: May 21, 2024

(30) Foreign Application Priority Data
Dec. 9, 2021 (DE) 10 2021 132 462.9

(51) Int. Cl. H02J 7/00; B60L 50/64; B60L 58/22; H01M 10/42; H01M 10/48; H01M 50/51

(52) U.S. Cl. CPC H02J 7/007182; B60L 50/64; B60L 58/22; H01M 10/425; H01M 10/482; H01M 50/51; H02J 7/00032; H02J 7/0029; H02J 7/0063; H02J 7/00714; H01M 2220/20

(57) ABSTRACT

A vehicle battery with a plurality of interconnected galvanic cells that are electrically connected to one of the two poles of the battery via an electrical main branch having semiconductor switches which are arranged antiserially with respect to one another, the gate terminals of which being independently controllable. A method for operating a vehicle having the battery includes, before galvanic connection of the battery, a battery-external control device transmits to the control unit the command to switch the semiconductor switches of the main branch so as to block at least in the discharge direction, and to switch the semiconductor switches of the auxiliary branch so as to allow passage in the discharge direction.

### BACKGROUND AND SUMMARY

The invention relates to a vehicle battery having a plurality of interconnected galvanic cells which are electrically connected at one end to a positive pole of the vehicle battery and at the other end to a negative pole of the vehicle battery, wherein the galvanic cells are electrically connected to one of the two poles via at least one pair of semiconductor switches which are arranged antiserially with respect to one another. The invention further relates to a vehicle having at least one vehicle battery of this type. The invention also relates to a method for operating a vehicle having a vehicle battery of this type. The invention is particularly advantageously applicable to vehicles having a plurality of vehicle batteries, in particular a plurality of lithium-ion batteries.

Vehicles exist which comprise a plurality of vehicle batteries. In a vehicle having a plurality of lithium-ion batteries, the operation thereof is only possible by the interposition of DC voltage (or DC/DC) converters. To date, on the grounds of the flat no-load voltage characteristic (“open-circuit voltage” or “OCV”), it has not been possible for two batteries to be operated from a common source, such as a DC voltage generator (e.g. a starter generator), particularly if the DC voltage generator generates a higher voltage, e.g. 48 V, than the battery voltage, e.g. 12 V to 15 V. Accordingly, to date, a dedicated DC voltage converter has been required for each battery. This generates the disadvantage of additional components in the vehicle, and thus the reduction of available structural space, an increased weight and higher costs.

An object of the present invention is to at least partially overcome the disadvantages of the prior art.

This object is fulfilled by the features disclosed herein. Preferred embodiments can be inferred, in particular, from the present disclosure.

This object is fulfilled by a vehicle having a plurality of interconnected galvanic cells which are electrically connected at one end to a positive pole of the energy store, and at the other end to a negative pole of the energy store, wherein the galvanic cells are electrically connected to one of the two poles via a first electrical branch or path (described hereinafter, without limitation of generality, as a “main branch”), and the main branch comprises at least one pair of semiconductor switches which are arranged antiserially with respect to one another, and the gate terminals of which are actuatable in a mutually independent manner.

This vehicle battery provides an advantage, in that it permits the achievement of an automatic and situation-dependent limitation or suppression of the charging current and/or of the discharge current of galvanic cells. This, in turn, permits an advantageous enhancement of the protection of galvanic cells against overcharging, deep discharging or excessively high charging and discharging currents.

Moreover, load balancing between a plurality of vehicle batteries can thus be advantageously implemented. As a result, in turn, a plurality of vehicle batteries can also be connected to the same DC voltage generator, by the interposition of a common DC voltage converter, thereby saving costs, structural space and weight. Specifically, by the employment of a plurality of vehicle batteries according to the invention, load balancing can be achieved in the absence of a superordinate controller.

Additionally, the vehicle battery, by the employment of a superordinate controller, can be advantageously adjusted or adapted to specific vehicle states (e.g. ambient conditions such as external temperatures, etc., installation locations, malfunctions, etc.).

The vehicle battery is intended to supply one or more loads of a vehicle with electrical energy. In particular, the vehicle battery is chargeable by a DC voltage generator of the vehicle.

According to a further development, the galvanic cells are lithium-ion cells.

The galvanic cells can be interconnected in series and/or in parallel.

The positive pole of the vehicle battery can correspond to a terminal 30, and the negative pole to a terminal 31.

In particular, a pair of semiconductor switches which are arranged antiserially with respect to one another are to be understood as two serially-interconnected semiconductor switches, the same non-control terminals of which (in field effect transistors, e.g. the source terminals or drain terminals thereof) are mutually electrically connected and which, in the event of a non-actuated control terminal, thus conduct or interrupt electric current in a different direction (antiserially).

However, a pair of semiconductor switches which are arranged antiserially with respect to one another can also be understood as two serially interconnected semiconductor switches which, in turn, are antiserially interconnected with one or two series-connected semiconductor switches. This provides an advantage, in that it can be ensured that, in the event of a short-circuit on a semi-conductor switch, an isolating functionality is nevertheless maintained. By means of this redundancy, in turn, functional security is enhanced, as a result of which e.g. an ASIL (Automotive Safety Integrity Level) classification of C and/or D is achievable.

Thus, if the control terminals of semiconductor switches in a respective pair are actuatable in a mutually independent manner, four circuit states can be generated:
the control terminals of both semiconductor switches are actuated by a (sufficiently high) control voltage, such that both semiconductor switches assume a bidirectional on-state or conducting state. The two semiconductor switches thus practically form a short-circuit;
the control terminals of both semiconductor switches are not actuated, such that both semiconductor switches are non-conductive in a non-conducting direction. As a result of the antiserial arrangement, the two non-conducting directions are in mutual opposition, and the two semiconductor switches, in combination, function in a bidirectionally non-conductive manner;
a first semiconductor switch of the two semiconductor switches is actuated, and the other second semiconductor switch is not. Accordingly, the current path through the two semiconductor switches, in the forward direction of the second semiconductor switch, is (imperfectly) current-conducting, and in the opposing direction is not;
the first semiconductor switch is not actuated, and the second semiconductor switch is actuated. Accordingly, the current path through the two semiconductor switches, in the forward direction of the first semiconductor switch, is (imperfectly) current-conducting, and in the opposing direction is not.

Accordingly, by the corresponding actuation of semiconductor switches, the current path between the pole of the vehicle battery and the galvanic cells, in which the main branch is interposed, can be advantageously set in a variety of ways, namely, optionally bidirectionally conductive, bidirectionally non-conductive, conductive in the charging direction only, or conductive in the discharge direction only.

According to a further development, the semiconductor switches are field-effect transistors. According to a further development, the semiconductor switches are insulating layer field-effect transistors. According to a further development, the semiconductor switches are insulating layer field-effect transistors. According to a further development, the semiconductor switches are metal oxide semiconductor field-effect transistors (MOSFETs). According to a further development, the semiconductor switches are normally-conducting or, advantageously on safety grounds, normally non-conducting field-effect transistors. According to a further development, the semiconductor switches are normally non-conducting p-channel or, advantageously, n-channel field-effect transistors. The employment of normally non-conducting n-channel MOSFETs is particularly advantageous. The normally non-conducting n-channel MOSFETs in a pair can be mutually connected, for example, at their drain terminals or, advantageously, at their source terminals.

According to one embodiment, a second electrical branch or path (described hereinafter, without limitation of generality, as a “secondary branch”) is arranged electrically in parallel with the main branch, which comprises at least one pair of semiconductor switches which are arranged antiserially with respect to one another, the control terminals of which are actuatable in a mutually independent manner, and are electrically interconnected in series with an ohmic resistor. This provides an advantage in that, alternatively or additionally to current conduction between the relevant pole and the galvanic cells through the main branch, current conduction is also achievable through the secondary branch which, however, on the grounds of the ohmic resistor, carries a significantly lower current than the main branch. In turn, this provides an advantage in that, if a current flux is to be reduced in at least one direction (e.g. on the grounds that a cell voltage Ucell achieves an upper or lower limiting value, or on the grounds of an excessively high current strength), the current flux, in at least this direction, does not need to be entirely interrupted, but can simply be reduced. This is advantageous, e.g. at very low temperatures, at which the charging of a lithium-ion cell with only very low currents is permitted (e.g. a cell-related current of the order of <10 A), as a chemical process (or “plating”) will otherwise occur, which is damaging to the cell. However, a generator or DC voltage converter, which is typically rated for an on-board power supply network demand well in excess of 300 A, can only be accurately set for a charging current of less than 10 A with difficulty. By the secondary branch, an advantage is thus achieved, in that the generator or DC voltage converter can continue to operate at full capacity, and the vehicle battery executes its own protection of galvanic cells. A further advantage is provided in that, conversely to relays or bipolar transistors—which, in principle, are also employable for the prevention of any deep discharge or overcharging—a higher efficiency is achieved.

The semiconductor switches of the secondary branch can be configured in an analogous manner to the semiconductor switches of the main branch.

The control terminals of the main branch and the control terminals of the secondary branch can be actuated by respectively different or common drivers (also describable, in the case of FETs, as gate drivers). To this end, the drivers can apply a control voltage UGS to the control terminals which is lower than (e.g. UGS=0 V), or is at least equal to a threshold voltage Uth (UGS≥Uth), in response to which the semiconductor switch is switched to a non-conducting or conducting state.

According to a further development, the control terminals (in field-effect transistors, the gate terminals thereof) are mutually interconnected at a common node.

According to one configuration, the secondary electrical branch comprises exactly one pair of semiconductor switches which are arranged antiserially with respect to one another. This provides an advantage, in that only a limited number of components are required for the configuration of the secondary branch, which poses no problem, on the grounds of the low current strengths resulting from the ohmic resistor.

According to a further development, the secondary electrical branch comprises a plurality of pairs of semiconductor switches and an ohmic resistor, which are mutually electrically interconnected in parallel. This provides an advantage, in that the current strength of the current carried by the secondary branch is variably adaptable to the switch-on and switch-off of the respective parallel current paths in a step-wise manner.

According to one configuration, the ohmic resistor assumes a resistance value between 0.05 ohms and 1 ohm. An advantage is thus achieved, in that currents which are carried by the secondary branch only are significantly lower than currents which are carried by the main branch only (e.g. at a current strength of 5% to 10% of currents which are carried by the main branch only), but are nevertheless sufficiently high to permit the achievement of the above-mentioned advantages of the secondary branch.

According to one configuration, the main branch comprises a plurality of semiconductor switches which are arranged antiserially with respect to one another and are electrically interconnected in parallel. An advantage is thus achieved, in that the electric current which is carried by the main branch as a whole is divided between a plurality of parallel current paths, as a result of which the (e.g. thermal and/or microstructural) loading of individual current paths is reduced. The number of individual current paths which respectively comprise a pair of semiconductor switches can be dependent, for example, upon the following:
the maximum outputtable current and/or the maximum current demand of the on-board power supply system from the battery;
the type of semiconductor switches selected (semiconductor type, model, etc.);
the cooling concept employed for the maximum desirable/permissible temperature of the vehicle battery in its site of installation;
costs
the requisite structural space; and/or
a maximum desirable/permissible power loss.

As a tendential consequence, e.g. the higher the number of electrically parallel current paths is appropriate, the higher the maximum outputtable current and/or the maximum current demand.

By way of a capability for the mutually independent actuation of the control terminals of mutually electrically parallel-interconnected pairs on the main branch, according to one configuration, it is provided that semiconductor switches which, in a non-conducting circuit, are (imperfectly) conducting in the same current direction, are simultaneously switched to a conducting or non-conducting state. In other words, in this configuration, all the semiconductor switches of the main branch which, at the same non-control terminals, are connected to the same node (e.g. the source terminals of which are mutually connected and the gate terminals of which are mutually connected) are synchronously actuated.

According to one configuration, the semiconductor switches are MOSFETs, and the source terminals or drain terminals of each pair are mutually electrically connected.

According to one configuration, the control terminals are actuatable by a control unit which is integrated in the vehicle battery. This provides an advantage, in that the vehicle battery can independently determine the direction and, optionally, the strength of the current flowing to the galvanic cells.

According to one configuration, the main branch electrically connects a positive pole of the battery to the galvanic cells.

According to one configuration, the vehicle battery is designed to measure a cell voltage which is present on at least one of the galvanic cells, and the control unit is designed:
to switch the semiconductor switches of the main branch to a non-conducting state for the charging direction of current, if the cell voltage achieves or exceeds a stipulated upper limiting value;
and/or
to switch the semiconductor switches of the main branch to a non-conducting state for the discharging direction of current, if the cell voltage achieves or undershoots a stipulated lower limiting value.

An advantage is thus achieved, in that any further charging of galvanic cells is prevented upon the achievement of the upper limiting value, thus permitting an extension of the service life thereof. With respect to the vehicle, an advantage is achieved in that the generator or DC voltage converter can be operated with its full dynamic characteristic, with no necessity for consideration as to whether a further current injection into this battery is permissible. Accordingly, in the presence of a second vehicle battery, the latter can firstly be fully charged. The full range of the state-of-charge (SoC) can thus be employed, which impacts favorably upon costs and structural space; it would otherwise be necessary for a reserve SoC to be maintained at all times, for control fluctuations in the on-board power supply system.

An analogous advantage is achieved, in that any further discharge of galvanic cells is prevented upon the achievement of the lower limiting value, which can likewise permit an extension of the service life thereof, e.g. by the prevention of any deep discharge. Where two or more vehicle batteries are installed, blocking of the charging direction prevents any constant transfer of charge, and thus the mutual draining of the plurality of batteries. Instead, it is automatically achieved that at least one battery is non-conducting in the charging direction, when the generator/DC voltage converter is switched off. With respect to the vehicle, a further advantage is achieved in that the generator or DC voltage converter can be operated with its full dynamic characteristic, with no necessity for consideration as to whether any further supply of this battery is required. Accordingly, in turn, any derating is prevented. Thus, in the presence of a second vehicle battery, the latter can firstly be discharged down to the limit of a deep discharge.

According to an advantageous configuration, in the event that a secondary branch is additionally provided, the control unit is designed:
to switch or maintain the semiconductor switches of the secondary branch in a conducting state for the charging direction of current, if the cell voltage achieves or exceeds a stipulated upper limiting value;
and/or
to switch or maintain the semiconductor switches of the secondary branch in a conducting state for the discharging direction of current, if the cell voltage achieves or undershoots a stipulated lower limiting value.

An advantage is thus achieved, in that a permissible charging/discharging current does not generate any voltage dip (in the discharging direction) or any overvoltage (in the charging direction) in the on-board power supply system, or at least only by a stipulated value for the body diode of the respectively non-conducting semiconductor switch. In the secondary branch, the voltage value is dependent upon the current flowing therein and upon the resistance rating of the resistor which is installed therein.

According to one configuration, the vehicle battery is designed to measure a current strength of an electric current flowing to or from the galvanic cells (charging or discharging current), and the control unit is designed, in the event that the current strength exceeds a stipulated threshold value, to switch the pair of semiconductor switches in the main branch to a bidirectionally non-conducting state, and to switch the pair of semiconductor switches in the secondary branch to a conducting state, at least in the current direction. An advantage is thus achieved, in that any charging or discharging current which is potentially damaging to the galvanic cells is prevented, wherein this current is only routed via the secondary branch, and is limited by the ohmic resistor. Moreover, an advantage is thus achieved, in that components in the on-board power supply system are also protected, e.g. by an inrush current limitation for control devices in the on-board power supply system upon the switch-in of the battery. The same applies, in an analogous manner, to an “external charging/start-up” scenario, as a discharged lithium-ion battery represents a substantial sink for the donor vehicle/current path from the injection point to the battery. By this configuration, the loading of distribution boards/fuse boxes can be relieved in a current- or time-controlled manner.

The threshold value, for example, can be dependent upon the following:
a temperature of the galvanic cells;
a state-of-charge of a/the galvanic cell(s);
a temperature of the semiconductor switch;
an ambient temperature of a vehicle;
loading/voltage levels of the on-board power supply system (as a load, for example, the battery can be separated from the generator, in order to supply more energy for the on-board power supply system);
an I²t derating function (of a cable or plug fuse); and/or
a short-circuit detection function.

According to one configuration, the control unit assumes a data-link coupling to an off-battery control device of the vehicle, and the control device is designed to transmit operating parameters for the vehicle battery to the off-battery control device and/or to receive commands for the actuation of semiconductor switches from the off-battery control device. This permits an even more flexible employment of the vehicle battery. The off-battery control device can be e.g. an on-board computer and/or an energy management device.

The data-link coupling can be embodied e.g. by a data bus, for example a CAN bus.

Operating parameters which are to be communicated to the off-battery control device can include, for example:
a state-of-charge (SoC) of the vehicle battery or of the galvanic cells;
a state-of-health (SoH) of the vehicle battery or of the galvanic cells.

The object is further fulfilled by a vehicle having at least one vehicle battery of the above-mentioned type. The vehicle can be configured analogously to the vehicle battery, and provides the same advantages.

According to one configuration, the vehicle comprises a plurality of vehicle batteries, at least one vehicle battery of which is a vehicle battery according to one of the preceding claims. This provides an advantage, in that load balancing is also independently executable, particularly in the event that a plurality of vehicle batteries are configured as described above.

The object is moreover fulfilled by a method for operating a vehicle having a vehicle battery of the above-mentioned type. The method can be configured analogously to the vehicle battery and the vehicle battery, and provides the same advantages.

According to one configuration, prior to the galvanic connection of the poles of the vehicle battery to an on-board power supply system by the off-battery control device, a command is transmitted to the control unit for the switching of semiconductor switches on the main branch to a non-conducting state, at least in the discharging direction, and for the switching of semiconductor switches on the secondary branch to a conducting state in the discharging direction. This command can be communicated e.g. via a previously established data link, e.g. a CAN bus.

The above-mentioned properties, features and advantages of the present invention, and the manner in which these are achieved, is clarified and elucidated in conjunction with the following schematic representation of an exemplary embodiment, which is described in greater detail with reference to the drawings.

### BRIEF DESCRIPTION OF THE DRAWINGS

FIG. 1 shows an equivalent circuit diagram of a vehicle battery according to the present disclosure; and

FIG. 2 shows a potential flow diagram for the actuation of semiconductor switches of the vehicle battery.

### DETAILED DESCRIPTION OF THE DRAWINGS

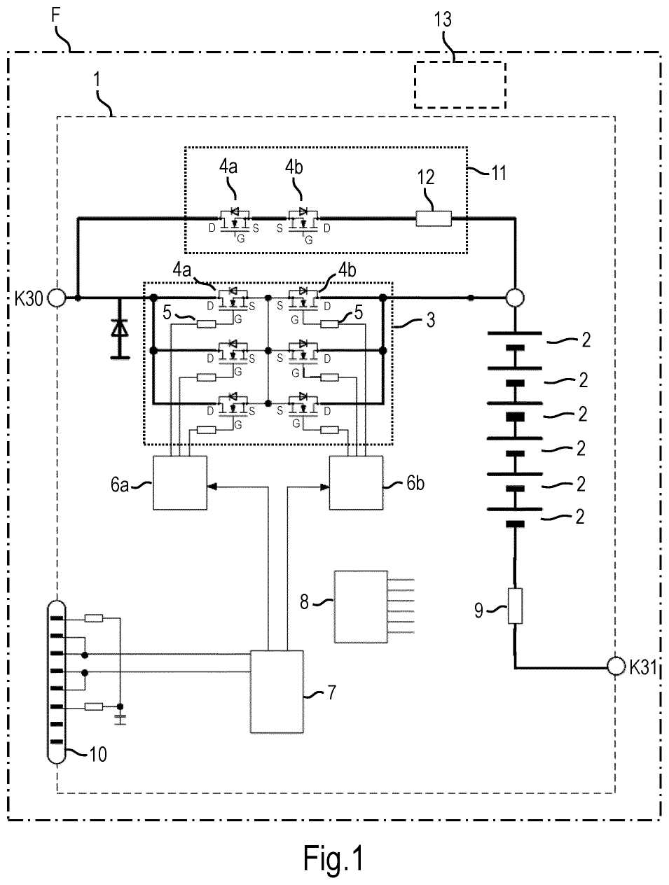

FIG. 1 shows an equivalent circuit diagram of a vehicle battery according to the present disclosure having a plurality of, in this case, series or serially interconnected galvanic lithium-ion cells 2, which are electrically connected at one end to a positive pole K30 of the vehicle battery 1 and at the other end to a negative pole K31 of the vehicle battery 1. In this case, the galvanic cells 2 are electrically connected to a positive pole K30 via a first electrical branch (“main branch”) 3. The main branch 3, for exemplary purposes only, comprises three mutually parallel-connected pairs respectively of two semiconductor switches 4a and 4b, which are arranged antiserially with respect to one another.

The semiconductor switches 4a and 4b are configured here as normally non-conducting n-channel MOSFETs which, in the event of the application of a (sufficiently high) gate voltage at their gate terminal G, are bidirectionally conductive (wherein this can also be described as “switched to a conducting state”) whereas, in the absence of the application of a (sufficiently high) gate voltage, they are only conductive from their source terminal S to their drain terminal D (wherein this can also be described as “switched to a non-conducting state”) whereas, in the converse direction, they execute a non-conducting function, as indicated by the diode symbols. If no (sufficiently high) gate voltage is applied, a voltage drop occurs in the forward direction, which typically ranges from 0.5 V to 1 V, independently of the current.

In the present case, the semiconductor switches 4a and 4b of the main branch 3 are mutually connected at their source terminals S, which corresponds to an antiserial arrangement. The drain terminals D of the semiconductor switches 4a are connected to the positive pole K30, whereas the drain terminals D of the semiconductor switches 4b are connected to the positive pole of the series-connected circuit of galvanic cells 2.

The gate terminals G of a respective pair 4a, 4b, which function as control terminals, are actuatable in a mutually independent manner, i.e. it is not necessary for a gate voltage to be applied simultaneously to the gate terminals G of a respective pair 4a, 4b, although such application is possible. Thus, in particular, at a specific time point, a gate voltage can be applied to the gate terminal G of the semiconductor switch 4a, whereas no gate voltage is applied to the gate terminal G of the semiconductor switch 4b, or vice versa.

In the present case, the gate terminals G of the semiconductor switches 4a of the main branch 3 which are connected to the positive pole K30—optionally via a respective gate series resistor 5—are connected to a common gate driver 6a of the vehicle battery 1, by which the semiconductor switches 4a are simultaneously switched to a conducting or non-conducting state. In an analogous manner, the gate terminals G of the semiconductor switches 4b of the main branch 3 which are connected to the series-connected circuit of galvanic cells 2 are connected to a common gate driver 6b of the vehicle battery 1, by which the semiconductor switches 4a are simultaneously switched to a conducting or non-conducting state, in principle, however, independently of the semiconductor switches 4a.

In the vehicle battery 1, a control unit 7, e.g. a microcontroller, an ASIC or a FPGA, is additionally integrated, which actuates the gate drivers 6a and 6b for the output of the respective gate voltages. The gate terminals G are thus actuatable, by the control unit 7, via the gate drivers 6a and 6b.

The control unit 7 can be connected to an analog frontend 8, which is designed to measure the cell voltage Ucell on at least one of the galvanic cells 2, e.g. by a shunt 9, to measure the current strength of the current flowing between the negative pole K31 and the series-connected circuit of galvanic cells 2, to digitize the latter and execute the transmission thereof to the control unit 7. The control unit 7 is designed to switch the semiconductor switches 4a and 4b, in accordance with the at least one measured cell voltage Ucell and/or in accordance with the measured current strength.

The control unit 7 is coupled in a data-linked manner via a bus interface 10, e.g. a CAN bus, to an (unrepresented) off-battery control device of the vehicle 1 such as, e.g. an energy manager, an on-board computer, etc., in a data-linked arrangement. The control unit 7 is designed to transmit operating parameters for the vehicle battery 1, such as the cell voltage Ucell, a state-of-charge (SoC), a state-of-health (SoH), etc. to the off-battery control device, and/or to receive commands for the actuation of the semiconductor switches 4a, 4b from the off-battery control device.

In an electrically parallel arrangement to the main branch 3, optionally, a second electrical branch (“secondary branch” 11) is provided between the positive pole K30 and the positive side of the series-connected circuit of galvanic cells 2 which, in the manner of one of the pairs of semiconductor switches 4a, 4b of the main branch 3, comprises two semiconductor switches 4a and 4b in the form of normally non-conducting n-channel MOSFETs, which are arranged antiserially with respect to one another. The gate terminals G thereof are actuatable in a mutually independent manner, and independently of the gate terminals G of the semiconductor switches 4a and 4b of the main branch 3.

In the secondary branch 11, an ohmic resistor 12 is arranged in an electrical series connection with the semiconductor switches 4a and 4b. This resistor advantageously assumes a resistance rating between 0.05 ohms and 1 ohm.

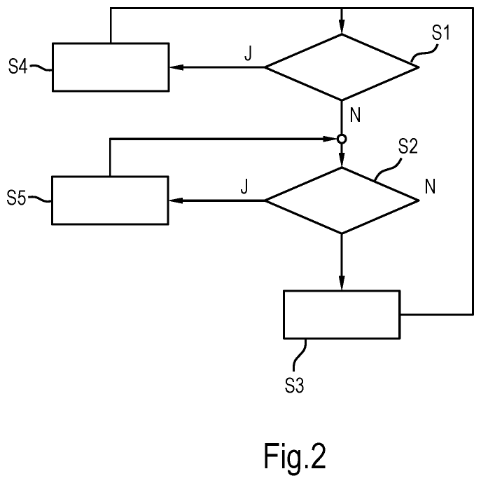

According to a further development, the control unit 7 can be designed to actuate the semiconductor switches 4a and 4b of the main branch 3 and, where present, of the secondary branch 11, in accordance with the measured cell voltage Ucell, as further described in greater detail hereinafter with reference to the flow diagram according to FIG. 2.

According to this further development, the control unit 7, as represented in step S1, is designed, for example, to execute a check as to whether the measured value of the cell voltage Ucell achieves or overshoots a stipulated upper limiting value Ucell,upper, i.e. as to whether Ucell≥Ucell, upper or Ucell>Ucell,upper applies.

If this is not the case (“N”), the control unit 7 can be designed, as represented in step S2, to execute a check as to whether the measured value of the cell voltage Ucell achieves or undershoots a stipulated lower limiting value Ucell,lower, i.e. as to whether Ucell≤≤Ucell,lower or Ucell<Ucell,lower applies.

If this is also not the case (“N”), and the measured value of the cell voltage Ucell thus lies between these two threshold values Ucell, upper, Ucell,lower, the control unit 7 can be designed to switch both semiconductor switches 4a and 4b of the main branch 3, by a gate voltage output, to a bidirectionally conducting state, as indicated by step S3. Accordingly, the main branch 3 thus assumes a practically zero-resistance, and the positive pole K30 is linked directly to the galvanic cells 2. In particular, the provision of a plurality of parallel current paths on the main branch 3 thus provides an advantage, in that even high electric currents can be conducted in a problem-free manner, from both the positive pole K30 to the galvanic cells 2, in the event of a charging of the cells 2, and in the converse direction, in the event of a discharging of the galvanic cells 2.

In the event that the cell voltage Ucell achieves or exceeds the stipulated upper limiting value Ucell,upper (“J” in step S1), it is desirable that the galvanic cells 2 should not be charged further, or only charged with a low current.

If the secondary branch 11 is not present, the semiconductor switches 4a, as indicated by step S4, by the switch-out of the gate voltage, are switched to a non-conducting state in the sense that, as indicated by the diode symbols, they execute an isolating function for charging currents from the positive pole K30 to the galvanic cells 2, but conduct discharging currents in the opposing direction—at the cost of a voltage loss. The semiconductor switches 4b, conversely, by the application of the gate voltage, remain bidirectionally conductive. By this circuit arrangement, the galvanic cells 2, by the supply of loads on the vehicle F, continue to be discharged until such time as the cell voltage Ucell falls back below the upper limiting value Ucell,upper. Thereafter, the semiconductor switches 4a can be switched back to a conducting state.

If the secondary branch 11 is also present, in the event that the cell voltage Ucell achieves or exceeds a stipulated upper limiting value Ucell,upper, in step S4, for example, both semiconducting switches 4a and 4b of the secondary branch 11 can be switched to, or maintained in a bidirectionally conducting state by the application of a respective gate voltage. As a result, the galvanic cells 2, even in the event of an overshoot of an upper limiting value Ucell,upper, will continue to be charged but, on the grounds of the ohmic resistor 12, at a comparatively low current strength.

In the event that the cell voltage Ucell achieves or undershoot the stipulated lower limiting value Ucell,lower (“J” in step S1), it is desirable that no further discharging of the galvanic cells should be executed.

If the secondary branch 11 is not present, as indicated in step S5, the semiconductor switches 4a, by the output of a gate voltage, can be switched to a bidirectionally conducting state for charging currents from the positive pole K30 to the galvanic cells 2, whereas discharging currents in the opposing direction are blocked by the switching of the semiconductor switches 4b to a non-conducting state. By this circuit arrangement, the galvanic cells 2 can only be charged. Once the cell voltage Ucell has been restored above the lower limiting value Ucell,lower, the semiconductor switches 4b can again be switched to a conducting state.

If the secondary branch 11 is also present, in the event that the cell voltage Ucell achieves or undershoots the lower limiting value Ucell,lower, in step S5, in an analogous manner, the semiconductor switches 4a of the secondary branch 11, by the application of a respective gate voltage, can be switched to or maintained in a bidirectionally conducting state, whereas discharging currents in the opposing direction are blocked by the switching of the semiconductor switches 4b to a non-conducting state. Alternatively, the secondary branch 11 can assume, or be maintained in a non-conducting state.

In principle, the semiconductor switches 4a, 4b of the secondary branch 11 can be switched to, or maintained in a conducting state in all three of the above-mentioned cases or conditions of the cell voltage Ucell. For example, both semiconductor switches 4a and 4b can be switched to a non-conducting state, in the event that the vehicle battery 1 is to be isolated from the remainder of the vehicle F, e.g. where the vehicle F is parked, for the execution of repairs, for the replacement of a battery, etc.

If a vehicle F having a vehicle battery 1 comprises at least one further vehicle battery 13, in particular of the type according to the present disclosure, an advantage is achieved in that, by the automatic and situation-dependent limitation or suppression of the charging current and/or of the discharging current, the vehicle batteries can be connected to the same DC voltage generator, by the interposition of a common DC voltage converter. Specifically, by a plurality of vehicle batteries according to the present disclosure, load balancing can be achieved in the absence of a superordinate controller. Additionally, the vehicle battery, by the employment of a superordinate controller, can be advantageously adjusted to specific vehicle states (e.g. ambient conditions such as external temperatures, etc., installation locations, malfunctions, etc.).

Naturally, the present invention is not limited to the exemplary embodiment represented.

In general, “a”, “an”, etc. can be understood as a singularity or as a plurality, particularly in the sense of “at least one” or “one or more”, etc., provided that this is not expressly excluded, e.g. by the term “exactly one”, etc.

Likewise, an indication of number can comprise exactly the number indicated, or can include a customary tolerance range, provided that this is not expressly excluded.

### LIST OF REFERENCE SYMBOLS

1 Vehicle battery
2 Galvanic cell
3 Main branch
4a Semiconductor switch
4b Semiconductor switch
5 Gate series resistor
6a Gate driver
6b Gate driver
7 Control unit
8 Analog frontend
9 Shunt
10 Bus interface
11 Secondary branch
12 Ohmic resistor
13 Further vehicle battery
D Drain terminal
F Vehicle
G Gate terminal
K30 Positive pole
K31 Negative pole
S Source terminal
S1-S5 Process steps

1-15. (canceled)

16. A vehicle battery comprising:
a plurality of interconnected galvanic cells which are electrically connected at one end to a positive pole of the vehicle battery and at another end to a negative pole of the vehicle battery, wherein the galvanic cells are electrically connected to one of the two poles via an electrical main branch,
wherein the electrical main branch comprises at least one pair of semiconductor switches that are arranged antiserially with respect to one another, and
wherein control terminals of the pair of semiconductor switches are actuatable in a mutually independent manner.

17. The vehicle battery according to claim 16,
wherein an electrical secondary branch is arranged electrically in parallel with the electrical main branch, wherein the electrical secondary branch comprises at least one second pair of semiconductor switches which are arranged antiserially with respect to one another,
wherein control terminals of the at least one second pair of semiconductor switches are actuatable in a mutually independent manner, and are electrically interconnected in series with an ohmic resistor.

18. The vehicle battery according to claim 17,
wherein the electrical secondary branch comprises exactly one second pair of semiconductor switches that are arranged antiserially with respect to one another.

19. The vehicle battery according to claim 17,
wherein the ohmic resistor has a resistance value between 0.05 ohms and 1 ohm.

20. The vehicle battery according to claim 16, wherein the electrical main branch comprises a plurality of mutually parallel-connected pairs of semiconductor switches that are arranged antiserially with respect to one another, the control terminals of which are actuatable in a mutually independent manner.

21. The vehicle battery according to claim 16,
wherein all the semiconductor switches of the electrical main branch that, in a non-conducting circuit, are conductive in a same current direction, are simultaneously switchable or switched to a non-conducting or conducting state.

22. The vehicle battery according to claim 16,
wherein the semiconductor switches are MOSFETs, and
wherein source terminals or drain terminals of each pair of semiconductor switches are mutually electrically connected.

23. The vehicle battery according to claim 16,
wherein the control terminals are actuatable by a control unit that is integrated in the vehicle battery.

24. The vehicle battery according to claim 16,
wherein the electrical main branch electrically connects the positive pole of the vehicle battery to the galvanic cells.

25. The vehicle battery according to claim 16,
wherein the vehicle battery is configured to measure a cell voltage present on at least one of the galvanic cells,
wherein the vehicle battery comprises a control unit configured to:
switch the semiconductor switches of the electrical main branch to a non-conducting state for a charging direction of current in response to the cell voltage achieving or exceeding a stipulated upper limiting value; and/or
switch the semiconductor switches of the electrical main branch to a non-conducting state for a discharging direction of current in response to the cell voltage achieving or undershooting a stipulated lower limiting value.

26. The vehicle battery according to claim 17, comprising:
a control unit configured to:
switch or maintain the semiconductor switches of the electrical secondary branch in a conducting state for a charging direction of current in response to a cell voltage achieving or exceeding a stipulated upper limiting value; and/or
switch or maintain the semiconductor switches of the electrical secondary branch in a conducting state for a discharging direction of current in response to the cell voltage achieving or undershooting a stipulated lower limiting value.

27. The vehicle battery according to claim 17,
wherein the vehicle battery is configured to measure a current strength of an electric current flowing to or from the galvanic cells,
wherein the vehicle battery comprises a control unit configured to, in response to the current strength exceeding a stipulated threshold value:
switch the pair of semiconductor switches in the electrical main branch to a bidirectionally non-conducting state; and
switch the pair of semiconductor switches in the electrical secondary branch to a conducting state, at least in a current direction.

28. The vehicle battery according to claim 16, comprising:
a control unit configured to:
assume a data-link coupling to an off-battery control device of the vehicle; and
transmit operating parameters for the vehicle battery to the off-battery control device and/or to receive commands for actuation of the semiconductor switches from the off-battery control device.

29. A vehicle comprising:
the vehicle battery according to claim 16.

30. A method for operating a vehicle having a vehicle battery, wherein the vehicle battery includes a plurality of interconnected galvanic cells electrically connected at one end to a positive pole of the vehicle battery and at another end to a negative pole of the vehicle battery, wherein the galvanic cells are electrically connected to one of the two poles via an electrical main branch, wherein the electrical main branch comprises at least one first pair of semiconductor switches that are arranged antiserially with respect to one another, wherein an electrical secondary branch is arranged electrically in parallel with the electrical main branch, wherein the electrical secondary branch comprises at least one second pair of semiconductor switches which are arranged antiserially with respect to one another, the method comprising:
prior to a galvanic connection of the vehicle battery, transmitting a command by an off-battery control device to a control unit of the vehicle battery for switching of the at least one first pair of semiconductor switches on the main branch to a non-conducting state, at least in a discharging direction, and for the switching the at least one second pair of semiconductor switches on the secondary branch to a conducting state in a discharging direction.
